(19) United States
(12) Patent Application Publication
(10) Pub. No.: US 2024/0220778 A1
(43) Pub. Date: Jul. 4, 2024

(54) SYSTEMS AND METHODS FOR EVALUATING MACHINE-LEARNING MODELS AND PREDICTIONS

(71) Applicant: Squint AI Inc., Waterloo (CA)

(72) Inventors: Kenneth Wenger, Mississauga (CA); Damian Brunt Fozard, Waterloo (CA)

(21) Appl. No.: 18/393,776

(22) Filed: Dec. 22, 2023

Related U.S. Application Data
(60) Provisional application No. 63/478,230, filed on Jan. 3, 2023.

(51) Int. Cl. G06N 3/0464

(52) U.S. Cl. CPC G06N 3/0464

(57) ABSTRACT

Various methods and systems for evaluating a performance of a machine-learning model are disclosed herein. The systems and methods disclosed herein can involve applying the machine-learning model to a set of inputs to generate a prediction for each input, applying data analytics algorithms to an intermediary output of the machine learning model or to the set of inputs to associate an input value to each input, evaluating the input values to determine whether the input values are associated with performance indicators indicating that the machine-learning model is performing poorly, and in response to determining that the input values are associated with performance indicators, determining a measure of performance of the machine-learning model based on the performance indicators or the prediction generated, and generating a recommendation for improving the performance of the machine-learning model. Various methods and systems for improving a prediction of a machine-learning model are also disclosed herein.

### CROSS-REFERENCE TO RELATED APPLICATIONS

This application claims the benefit of U.S. Provisional Patent Application No. 63/478,230, filed on Jan. 3, 2023. The entire content of U.S. Provisional Patent Application No. 63/478,230 is hereby incorporated by reference.

### FIELD

The described embodiments relate to a machine-learning model evaluation system, and methods of operating thereof.

### BACKGROUND

Machine-learning models are typically used for making predictions in respect of raw data. Example predictions in respect of the raw data can include, but are not limited to, classification of raw images. The predictions generated from applying the machine-learning models can be incorrect. Traditional methods for resolving the errors can include the use of a more powerful machine-learning model to enhance the prediction. The more powerful machine-learning model can be generated by increasing the size of the model itself, and by using a significantly larger training data set (in comparison with the machine-learning model that resulted in the error) that may require more computing time and/or resources to generate the prediction. As a result, excessive use and/or reliance on these more powerful machine-learning models can result in computational delays, and/or unnecessary resource consumption, or may be computationally intractable in use cases.

### SUMMARY

The various embodiments described herein generally relate to machine-learning model evaluation systems and methods of operating thereof. The disclosed methods and systems can, in some embodiments, relate to improving a prediction generated from applying a machine-learning model.

In accordance with an example embodiment, there is provided a system for evaluating a performance of a machine-learning model. The system includes a database having a set of inputs stored thereon and a processor in communication with the database. The processor is operable to: apply the machine-learning model to the set of inputs to generate a prediction for each of the inputs in the set of inputs; apply one or more data analytics algorithms to one of an intermediary output of the machine-learning model and the set of inputs for associating an input value to each input of the set of inputs; evaluate the input values associated with the set of inputs to determine whether one or more input values are associated with one or more performance indicators indicating the machine-learning model is performing poorly; in response to determining the one or more input values are associated with the one or more performance indicators indicating the machine-learning model is performing poorly, determine a measure of performance for the machine-learning model, the measure of performance being determined based on one or more of the performance indicators and the input values associated with the set of inputs, and the prediction generated for the inputs; and generate a recommendation for improving the performance of the machine-learning model based at least on one or more of the one or more performance indicators and the measure of performance.

In some embodiments, the set of inputs comprises images.

In some embodiments, the prediction is a classification prediction assigning one class of a plurality of classes to each of the inputs.

In some embodiments, the processor is operable to: apply the machine-learning model to a set of training inputs to generate a prediction for each of the training inputs in the set of training inputs; apply the one or more data analytics algorithms to one of the intermediary output of the machine-learning model and the set of training inputs for associating a training input value to each training input of the set of inputs; evaluate the training input values associated with the set of training inputs to determine one or more substandard characteristics indicating the machine-learning model is performing poorly; and determine the one or more performance indicators based at least on the one or more substandard characteristics and the training input values associated with the one or more substandard characteristics.

In some embodiments, the one or more data analytics algorithms comprise one or more clustering algorithms.

In some embodiments, applying the one or more clustering algorithms to one of the intermediary output of the machine-learning model and the set of inputs comprises obtaining a plurality of datapoint clusters corresponding to the plurality of classes.

In some embodiments, the processor is operable to display one or more cluster graphs associated with the plurality of input values.

In some embodiments, applying the one or more data analytics algorithms comprises determining, for the intermediary output of the machine-learning model, a plurality of similarity scores, wherein each similarity score indicates a similarity between a first input value of the plurality of input values and a second input value of the plurality of input values based on a comparison metric between the first input value and the second input value.

In some embodiments, evaluating the input values comprises evaluating one or more of a relationship between two or more clusters, an edge of one or more clusters, a relationship between a plurality of input values within a cluster, a distance of an input value to a centroid of one or more clusters and a measure of clustering of one or more clusters of the plurality of input values.

In some embodiments, applying one or more data analytics algorithms to one of an intermediary output of the machine-learning model and the set of inputs comprises applying one or more of a K-Means clustering algorithm and a t-distributed stochastic neighbor embedding (t-SNE) clustering algorithm.

In some embodiments, for the training inputs associated with the subset of training input values associated with the substandard characteristics, the processor is further operable to determine a plurality of attributes of the training inputs evaluated by the machine-learning model to generate the prediction; determine a subset of shared attributes within the plurality of attributes; and determine the one or more performance indicators based on the determined subset of shared attributes.

In some embodiments, determining the plurality of attributes of the training inputs comprises determining the plurality of attributes of a subset of training inputs, the subset of training inputs associated with one or more of: one or more clusters of the plurality of training input values, a region within a cluster and one or more training input values within the subset of training input values associated with the machine-learning model performing poorly.

In some embodiments, the processor is operable to determine a plurality of attributes of the inputs evaluated by the machine-learning model to generate the prediction; and determine the measure of performance of the machine-learning model based at least on a comparison of the plurality of attributes evaluated by the machine-learning model and the subset of shared attributes.

In some embodiments, evaluating the plurality of training input values to identify the subset of training input values associated with substandard characteristics comprises identifying one or more prediction outcomes associated with the machine-learning model performing poorly and evaluating the plurality of training input values associated with the one or more prediction outcomes.

In some embodiments, the one or more prediction outcomes comprise one or more classifications.

In some embodiments, the processor is further operable to evaluate the prediction to determine a measure of confidence for the prediction for each of the training inputs in the set of training inputs; evaluate the training input values associated with a low measure of confidence for the prediction to identify the substandard characteristics; and determine the one or more performance indicators based on the identified substandard characteristics associated with the training input values.

In some embodiments, the machine-learning model performing poorly is associated with the measure of confidence for the prediction.

In some embodiments, the machine-learning model performing poorly is associated with the measure of confidence for the prediction falling below a confidence threshold.

In some embodiments, determining the one or more performance indicators comprises: evaluating a first plurality of training input values obtained according to a first data analytics algorithm to identify one or more first substandard characteristics of a first subset of input values associated with the machine-learning model performing poorly; evaluating a second plurality of training input values obtained according to a second clustering data analytics algorithm to identify one or more second substandard characteristics of a second subset of input values associated with the machine-learning model performing poorly; and determining the one or more performance indicators based on the first substandard characteristics and the second substandard characteristics.

In some embodiments, determining the one or more performance indicators comprises identifying one or more classes associated with the machine-learning model performing poorly.

In some embodiments, determining the one or more performance indicators comprises identifying whether the prediction is associated with a prediction outcome associated with the machine-learning model performing poorly.

In some embodiments, each input value corresponds to a numerical representation of an input of the set of inputs.

In accordance with an embodiment, there is provided a method for evaluating a performance of a machine-learning model. The method comprises operating the processor to: apply the machine-learning model to a set of inputs to generate a prediction for each input of the set of inputs; apply the machine-learning model to the set of inputs to generate a prediction for each of the inputs in the set of inputs; apply one or more data analytics algorithms to one of an intermediary output of the machine-learning model and the set of inputs for associating an input value to each input of the set of inputs; evaluate the input values associated with the set of inputs to determine whether one or more input values are associated with one or more performance indicators indicating the machine-learning model is performing poorly; in response to determining the one or more input values are associated with the one or more performance indicators indicating the machine-learning model is performing poorly, determine a measure of performance for the machine-learning model, the measure of performance being determined based on one or more of the performance indicators and the input values associated with the set of inputs, and the prediction generated for the inputs; and generate a recommendation for improving the performance of the machine-learning model based at least on one or more of the one or more performance indicators and the measure of performance.

In some embodiments, the set of inputs comprises images.

In some embodiments, the prediction is a classification prediction assigning one class of a plurality of classes to each of the inputs.

In some embodiments, the method further comprises operating the processor to: apply the machine apply the machine-learning model to a set of training inputs to generate a prediction for each of the training inputs in the set of training inputs; apply the one or more data analytics algorithms to one of the intermediary output of the machine-learning model and the set of training inputs for associating a training input value to each training input of the set of inputs; evaluate the training input values associated with the set of training inputs to determine one or more substandard characteristics indicating the machine-learning model is performing poorly; and determine the one or more performance indicators based at least on the one or more substandard characteristics and the training input values associated with the one or more substandard characteristics.

In some embodiments, the one or more data analytics algorithms comprise one or more clustering algorithms.

In some embodiments, applying the one or more clustering algorithms to one of the intermediary output of the machine-learning model and the set of inputs comprises obtaining a plurality of datapoint clusters corresponding to the plurality of classes.

In some embodiments, the method further comprises operating the processor to display one or more cluster graphs associated with the plurality of input values.

In some embodiments, applying the one or more data analytics algorithms comprises determining, for the intermediary output of the machine-learning model, a plurality of similarity scores, wherein each similarity score indicates a similarity between a first inputs value of the plurality of input values and a second inputs value of the plurality of input values based on a comparison metric between the first input value and the second input value.

In some embodiments, evaluating the input values comprises evaluating one or more of a relationship between two or more clusters, an edge of one or more clusters, a relationship between a plurality of input values within a cluster, a distance of an input value to a centroid of one or more clusters and a measure of clustering of one or more clusters of the plurality of input values.

In some embodiments, applying one or more data analytics algorithms to one of an intermediary output of the machine-learning model and the set of inputs comprises applying one or more of a K-Means clustering algorithm and a t-distributed stochastic neighbor embedding (t-SNE) clustering algorithm.

In some embodiments, the method further comprises operating the processor to: for the training inputs associated with the subset of training input values associated with the substandard characteristics, determine a plurality of attributes of the training inputs evaluated by the machine-learning model to generate the prediction; determine a subset of shared attributes within the plurality of attributes; and determine the one or more performance indicators based on the determined subset of shared attributes.

In some embodiments, determining the plurality of attributes of the training inputs comprises determining the plurality of attributes of a subset of training inputs, the subset of training inputs associated with one or more of: one or more clusters of the plurality of training input values, a region within a cluster and one or more training input values within the subset of training input values associated with the machine-learning model performing poorly.

In some embodiments, the method further comprises operating the processor to determine a plurality of attributes of the inputs evaluated by the machine-learning model to generate the prediction; and determine the measure of performance of the machine-learning model based at least on a comparison of the plurality of attributes evaluated by the machine-learning model and the subset of shared attributes.

In some embodiments, evaluating the plurality of training input values to identify the subset of training input values associated with substandard characteristics comprises identifying one or more prediction outcomes associated with the machine-learning model performing poorly and evaluating the plurality of training input values associated with the one or more prediction outcomes.

In some embodiments, the one or more prediction outcomes comprise one or more classifications.

In some embodiments, the method further comprises operating the processor to: evaluate the prediction to determine a measure of confidence for the prediction for each of the training inputs in the set of training inputs; evaluate the training input values associated with a low measure of confidence for the prediction to identify the substandard characteristics; and determine the one or more performance indicators based on the identified substandard characteristics associated with the training input values.

In some embodiments, the machine-learning model performing poorly is associated with the measure of confidence for the prediction.

In some embodiments, the machine-learning model performing poorly is associated with the measure of confidence for the prediction falling below a confidence threshold.

In some embodiments, evaluating the plurality of input values comprises: evaluating a first plurality of input values obtained according to a first data analytics algorithm to identify one or more first substandard characteristics of a first subset of training input values associated with the machine-learning model performing poorly; evaluating a second plurality of input values obtained according to a second data analytics algorithm to identify one or more second substandard characteristics of a second subset of training input values associated with the machine-learning model performing poorly; and determining the one or more performance indicators based on the first substandard characteristics and the second substandard characteristics.

In some embodiments, determining the one or more performance indicators comprises identifying one or more prediction outcomes associated with the machine-learning model performing poorly.

In some embodiments, each input value corresponds to a numerical representation of an input of the set of inputs.

In another example embodiment, there is provided a system for improving a prediction generated by a machine-learning model. The system comprises a database having a set of inputs stored thereon and a processor in communication with the database. The processor is operable to apply the machine-learning model to the set of inputs to generate the prediction to each input of the set of inputs; determine likelihood of mistake for the prediction; and in response to determining that the prediction is associated with a high likelihood of mistake: evaluate one or more inputs of the set of inputs and the respective prediction to determine one or more causes for the high likelihood of mistake; define a preferred machine-learning model based on the one or more causes for reducing the likelihood of mistake for the prediction; and apply the preferred machine-learning model to one or more inputs of the set of inputs to generate a subsequent prediction for the one or more inputs.

In some embodiments, the prediction comprises a classification prediction assigning a class to each input of the set of inputs.

In some embodiments, the processor is operable to determine the likelihood of mistake of the prediction based on one or more performance indicators indicative of the machine-learning model performing poorly.

In some embodiments, the one or more performance indicators are based on one or more of: substandard characteristics of training input values associated with training inputs associated with the machine-learning model performing poorly associated and prediction outcomes associated with the machine-learning model performing poorly.

In some embodiments, the one or more performance indicators are stored in the database.

In some embodiments, the processor is operable to apply the preferred machine-learning model to one or more of one or more inputs of the set of inputs associated with the high likelihood of mistakes and inputs of the set of inputs associated with a class associated with the high likelihood of mistake.

In some embodiments, determining if the prediction is associated with a high likelihood of mistake comprises: determining a measure of confidence of the prediction for each of the one or more inputs; and determining if the measure of confidence falls below a confidence threshold; and in response to determining that the measure of confidence falls below a confidence threshold, determine that the prediction is associated with the high likelihood of mistake.

In some embodiments, the confidence threshold is based on a type of the set of inputs.

In some embodiments, the processor is operable to receive the confidence threshold.

In some embodiments, the preferred machine-learning model is selected based in part on the confidence threshold.

In some embodiments, the preferred machine-learning model is selected based on attributes of the one or more inputs evaluated by the machine-learning model to generate the prediction.

In some embodiments, the preferred machine-learning model is selected based on one or more of a type of the set of inputs and a class of the classification prediction.

In some embodiments, defining the preferred machine-learning model comprises one of selecting the preferred machine-learning model and generating the preferred machine-learning model.

In some embodiments, the machine-learning model is a convolutional neural network.

In some embodiments, the preferred machine-learning model is a convolutional neural network.

In some embodiments, the processor is operable to evaluate an intermediary state of the machine-learning model to determine the one or more causes of the high likelihood of misclassification.

In some embodiments, the processor is operable to evaluate a correctness of the subsequent prediction based on an expected state and an actual state of a system using the subsequent prediction.

In another example embodiment, there is provided a method for improving a prediction generated by a machine-learning model. The method comprises operating a processor to apply the machine-learning model to a set of inputs to generate prediction to each input in the set of inputs; determine a likelihood of mistake of the prediction; and in response to determining that the first prediction is associated with high likelihood of mistake: evaluate one or more inputs of the set of inputs and the respective prediction to determine one or more causes for the high likelihood of mistake; define a preferred machine-learning model based on the one or more causes for reducing the likelihood of mistake of the prediction; and apply the preferred machine-learning model to one or more inputs of the set of inputs to generate a subsequent prediction for the one or more inputs.

In some embodiments, the prediction comprises a classification prediction assigning a class to each of the inputs of the set of inputs.

In some embodiments, the method further comprises operating the processor to determine the likelihood of mistake of the classification prediction based on one or more performance indicators indicative of the machine-learning model performing poorly.

In some embodiments, the one or more performance indicators are based on one or more of: substandard characteristics of training input values associated with training inputs associated with the machine-learning model performing poorly associated and prediction outcomes associated with the machine-learning model performing poorly.

In some embodiments, wherein the method further comprises operating the processor to retrieve the one or more performance indicators from a database.

In some embodiments, the method further comprises operating the processor to apply the preferred machine-learning model to one or more of one or more inputs of the set of inputs associated with the high likelihood of misclassification and inputs of the set of inputs associated with a class associated with the high likelihood of mistake.

In some embodiments, determining if the prediction is associated with a high likelihood of mistake comprises: determining a measure of confidence of the prediction for each of the one or more images; and determining if the measure of confidence falls below a confidence threshold; and in response to determining that the measure of confidence falls below a confidence threshold, determine that the prediction is associated with the high likelihood of mistake.

In some embodiments, the confidence threshold is based on a type of the set of inputs.

In some embodiments, the method further comprises operating the processor to receive the confidence threshold.

In some embodiments, the preferred machine-learning model is selected based in part on the confidence threshold.

In some embodiments, the preferred machine-learning model is selected based on attributes of the one or more inputs evaluated by the machine-learning model to generate the classification prediction

In some embodiments, the preferred machine-learning model is selected based on one or more of a type of the set of inputs and an outcome of the prediction.

In some embodiments, the preferred machine-learning model requires more resources relative to the machine-learning model.

In some embodiments, the preferred machine-learning model comprises one of selecting the preferred machine-learning model and generating the preferred machine-learning model.

In some embodiments, the machine-learning model is a convolutional neural network.

In some embodiments, the preferred machine-learning model is a convolutional neural network.

In some embodiments, the method further comprises operating the processor to evaluate an intermediary state of the machine-learning model to determine the one or more causes of the high likelihood of mistake.

In some embodiments, the method further comprises operating the processor to evaluate a correctness of the subsequent prediction based on an expected state and an actual state of a system using the subsequent prediction.

### BRIEF DESCRIPTION OF THE DRAWINGS

Several embodiments will be described in detail with reference to the drawings, in which:

FIG. 1 is a block diagram of an example machine-learning model evaluation system in communication with example external components, in accordance with an example embodiment;

FIG. 2 is a flowchart of an example method for generating a prediction by a machine-learning model, in accordance with an example embodiment;

FIG. 3A shows an example image that may be classified by the machine-learning model;

FIG. 3B shows the image of FIG. 3A with added noise;

FIG. 3C shows an example cluster graph showing the images shown in FIGS. 3A-3B as datapoints;

FIG. 4A shows another example image that may be classified by the machine-learning model;

FIG. 4B shows an example cluster graph showing the image shown in FIG. 4A as a datapoint;

FIG. 5A shows another example image that may be classified by the machine-learning model;

FIG. 5B shows an example cluster graph showing the image shown in FIG. 5A as a datapoint;

FIG. 6 is a flowchart of an example method for evaluating a performance of a machine-learning model, in accordance with an example embodiment;

FIG. 7 shows an example cluster graph generated by the machine-learning model evaluation system disclosed herein;

FIG. 8A shows another example image that may be classified by the machine-learning model;

FIG. 8B shows an example cluster graph showing the image shown in FIG. 8A as a datapoint;

FIG. 9A shows an example image that may be misclassified by the machine-learning model;

FIG. 9B shows another example image that may be misclassified by the machine-learning model;

FIG. 9C shows an example cluster graph showing the images shown in FIGS. 9A-9B as a datapoints;

FIG. 10A shows example attributes evaluated by the machine-learning model for a misclassified image;

FIG. 10B shows example attributes evaluated by the machine-learning model for a misclassified image;

FIG. 11A example attributes evaluated by the machine-learning model for a correctly classified image;

FIG. 11B example attributes evaluated by the machine-learning model for a correctly classified image; and

FIG. 12 is a flowchart of an example method for improving a prediction generated by a machine-learning model, in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

Machine-learning models are typically used for making predictions in respect of raw data. Example predictions in respect of the raw data can include, but are not limited to, classification of raw images, text and numerical data.

Image classification in particular, can be used in a variety of fields, from object detection to automated inspection, to medical screening. To classify images, machine-learning models typically analyze input images, extract features from these images and evaluate the distribution of features of each class the models are trained to recognized to determine which distribution of features the input images are closest to. However, depending on the type of machine-learning model used and the images fed to the machine-learning model, mistakes can occur, and images can be misclassified. In some cases, depending on the use case, some level of misclassification can be tolerated. In other cases, however, a high level of accuracy may be required. In all cases, knowledge that a mistake in prediction has occurred can be important and, in many cases, sufficient.

To improve predictions, existing practice places emphasis on developing better, often more powerful machine-learning models to, for example, reduce misclassification to an acceptable range. However, better machine-learning models can be inefficient as they may not be applicable in all use cases. For example, in some cases, resources may not be available to apply a powerful machine-learning model during production environments with resource constraints. In other cases, basic machine-learning models may be sufficient for making predictions about certain types of inputs and the use of powerful machine-learning models may be an inefficient use of resources. In other cases, within a set of inputs, predictions about some inputs may be easily achieved using less powerful machine-learning models and may not require the use of a better machine-learning model, and accordingly the use of a more powerful machine-learning model may result in an inefficient use of resources. In all cases, even the best and most powerful machine-learning models can have limitation(s) and, in many cases, the resources expended to develop and use these powerful machine-learning models may be disproportionate relative to the incremental improvement in prediction they produce or the application for which they are used.

To improve predictions and improve the performance of machine-learning models generally, the disclosed systems and methods can evaluate the performance of a machine-learning model to identify where the machine-learning model is likely to make an erroneous prediction, for example, misclassify an input. As will be described, to evaluate the performance of a machine-learning model, the disclosed systems and methods apply a set of data analytics algorithms (e.g., similarity detection algorithms, clustering algorithms) to associate input values representative of the inputs to which the machine-learning model is applied to analyze the inputs as the machine-learning model sees them, and evaluate the input values to identify whether they are associated with features indicative of the machine-learning model performing poorly. By identifying these features, a measure of performance (e.g., the likelihood of a mistake in the prediction) of the machine-learning model can be determined. Accordingly, the disclosed systems and methods may determine that a machine-learning model is likely to make an erroneous prediction.

By identifying where the machine-learning model is likely to make an incorrect prediction for an input, through the use of these performance indicators, the disclosed systems and methods can in some cases, improve a prediction of the machine-learning model and/or provide recommendation(s) for improving the prediction. For example, the disclosed systems and methods can apply a preferred machine-learning model that can be selected to address the cause(s) of the high likelihood of mistake of the machine-learning model. The preferred machine-learning model can be a specialized, resource intensive model that is designed to address the cause of the mistake. As the preferred machine-learning model can be selected for the purpose of improving the prediction of the machine-learning model, the revised prediction obtained from the preferred machine-learning model can be more accurate than the initial prediction. As another example, the disclosed systems and methods can generate an alert to notify an operator. The type of recommendation(s) may be based on, for example, the use case. The disclosed systems and methods can be integrated into systems that operate with reference to predictions. In some cases, these disclosed systems can improve the predictions generated from applying a machine-learning model in real time, that is, during operation of the systems in which they are integrated.

By applying the preferred machine-learning model to only a subset of the inputs received by the machine-learning model, the methods and systems described herein can make a more efficient use of resources.

In some example embodiments, the disclosed systems can evaluate predictions generated from the application of multiple machine-learning models to then make a further prediction specific to the system. This can be one manner in which the disclosed systems and methods can evaluate the performance of multiple machine-learning models concurrently.

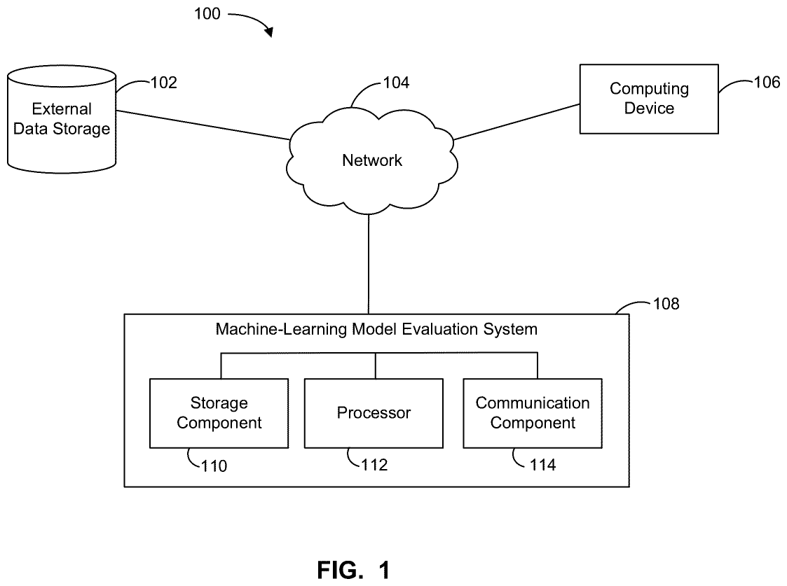

Reference is first made to FIG. 1, which illustrates an example block diagram 100 of a machine-learning model evaluation system 108 in communication with an external data storage 102 and a computing device 106 via a network 104. Although only one computing device 106 is shown in FIG. 1, the machine-learning model evaluation system 108 may be in communication with a greater number of computing devices 106. The machine-learning model evaluation system 108 can communicate with the computing device(s) 106 over a wide geographic area via the network 104. While the machine-learning model evaluation system 108 and the computing device 106 are shown as separate components, in some cases, the machine-learning model evaluation system 108 or one or more components of the machine-learning model evaluation system 108 may be implemented within the computing device 106. The machine learning model evaluation system 108 can be integrated into a system or used in combination with a system which uses outputs from one or more machine-learning models during operation (e.g., a vehicle with sensor systems).

The machine-learning model evaluation system 108 includes a storage component 110, a processor 112, and a communication component 114. The machine-learning model evaluation system 108 can be implemented with more than one computer server distributed over a wide geographic area and connected via the network 104. The storage component 110, the processor 112 and the communication component 114 may be combined into a fewer number of components or may be separated into further components.

The processor 112 can be implemented with any suitable processor, controller, digital signal processor, graphics processing unit, application specific integrated circuits (ASICs), and/or field programmable gate arrays (FPGAs) that can provide sufficient processing power for the configuration, purposes and requirements of machine-learning model evaluation system 108. The processor 112 can include more than one processor with each processor being configured to perform different dedicated tasks.

The communication component 114 can include any interface that enables the machine-learning model evaluation system 108 to communicate with various devices and other systems. For example, the communication component 114 can receive inputs (e.g., images, text, data) from the computing device 106 and store the inputs in the storage component 110 or external data storage 102. The processor 112 can then process the images according to the methods described herein.

The communication component 114 can include at least one of a serial port, a parallel port or a USB port, in some embodiments. The communication component 114 may also include an interface to component via one or more of an Internet, Local Area Network (LAN), Ethernet, Firewire, modem, fiber, or digital subscriber line connection. Various combinations of these elements may be incorporated within the communication component 114. For example, the communication component 114 may receive input from various input devices, such as a mouse, a keyboard, a touch screen, a thumbwheel, a trackpad, a track-ball, a card-reader, voice recognition software and the like depending on the requirements and implementation of the machine-learning model evaluation system 108.

The storage component 110 can include RAM, ROM, one or more hard drives, one or more flash drives or some other suitable data storage elements such as disk drives. The storage component 110 can include one or more databases for storing data related to the machine-learning models to be evaluated or applied and/or the machine-learning models themselves, data analytics algorithm(s) (e.g., similarity detection algorithms, clustering algorithm(s)), substandard characteristics for the machine-learning models, performance indicators for the machine-learning models, inputs (e.g., images, text, data), including training inputs, information about the inputs and the training inputs and prediction information related to the inputs and training inputs (e.g., classification information related to images).

The storage component 110 can store information related to the inputs, such as but not limited to, data analytics information associated with the inputs, cluster graphs associated with the inputs and heatmaps associated with the inputs corresponding to for example, attributes of the inputs analyzed by the machine-learning model.

The external data storage 102 can store data similar to that of the storage component 110. The external data storage 102 can, in some embodiments, be used to store data that is less frequently used and/or older data. In some embodiments, the external data storage 102 can be a third-party data storage stored with input data for analysis by the machine-learning model evaluation system 108. The data stored in the external data storage 102 can be retrieved by the computing device 106 and/or the machine-learning model evaluation system 108 via the network 102.

Images described herein can include any digital image of any reasonable size and resolution for image classification purposes. In some embodiments, the machine-learning model evaluation system 108 can apply image pre-processing to the images, such as but not limited to normalizing the pixel dimensions of an image and/or digital filtering for noise reduction and storing the pre-processed image as a version of the original image.

Other types of data, including textual data and numerical data, can include any type of data for which a prediction can be made. In some embodiments, the machine-learning model evaluation system 108 can pre-process the data, such that the data is in a format that can be used by the machine-learning model.

The computing device 106 can include any device capable of communicating with other devices through a network such as the network 104. A network device can couple to the network 104 through a wired or wireless connection. The computing device 106 can include a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

The network 104 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the machine-learning model evaluation system 108, the external data storage 102, and the computing device 106.

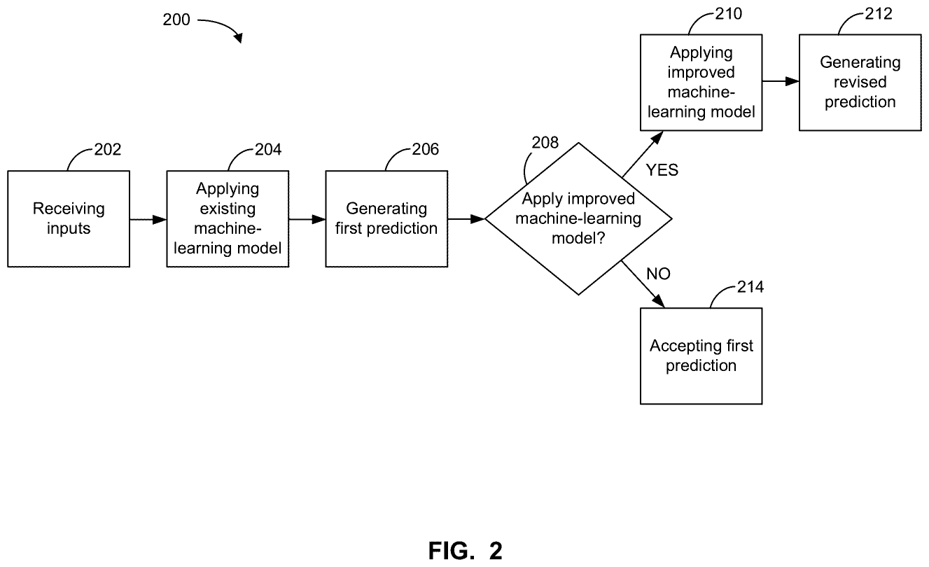

Reference will now be made to FIG. 2, which shows a flowchart 200 illustrating an example method of generating a prediction for an input using one or more machine-learning models. The prediction can, in some cases, be a classification prediction. In some embodiments, the machine-learning model(s) can be generated with a convolutional neural network.

The method shown in FIG. 2 can be conducted by the machine-learning model evaluation system 108 described herein. In some embodiments, the method described with reference to FIG. 2 can be conducted by an external system (not shown in FIG. 1) in communication with the machine-learning model evaluation system 108 via the network 104.

At 202, the machine-learning model evaluation system 108 receives inputs for which a prediction can be made. The inputs can be stored in the storage component 110 and/or the external data storage 102 and retrieved by the machine-learning model evaluation system 108 via the communication component 114 of the machine-learning model evaluation system 108.

At 204, the machine-learning model evaluation system 108 applies a machine-learning model to one or more inputs received at 202 to make a prediction about each of the inputs. For example, the machine-learning model may assign each input with to a classification. The machine-learning model may be stored in the storage component 110 and/or the external data storage 102.

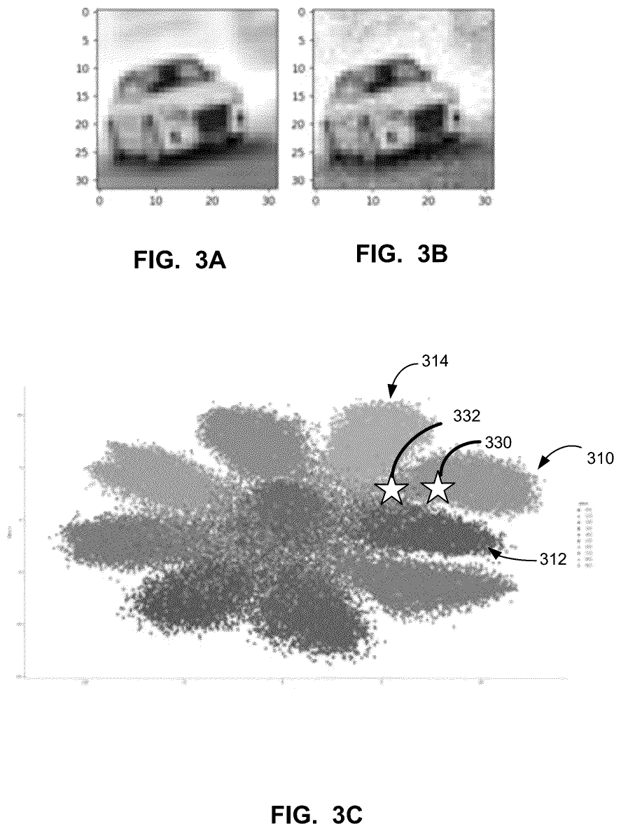

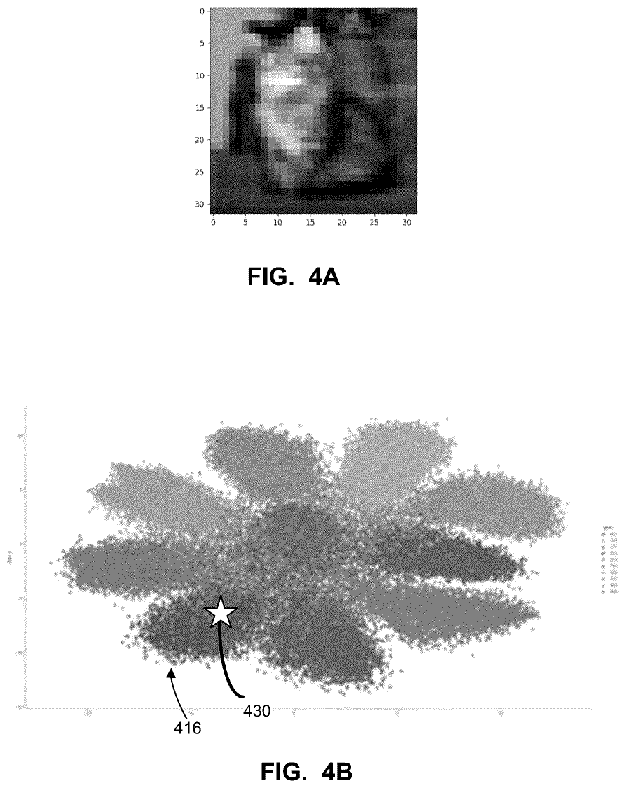

At 206, the machine-learning model evaluation system 108 generates a first prediction for each of the inputs received at 202. For image classification for example, the first prediction may be a class for the object(s) shown in the image. The class may be determined from a list of possible classes for the inputs. For example, referring briefly to FIG. 3A which shows an example image that may be classified by the machine-learning model, the machine-learning model may predict that the object shown in FIG. 3A is a car, with a 99.9% confidence. Similarly, referring briefly to FIG. 4A, the machine-learning may predict that the object shown is a cat with a 99.9% confidence.

At 208, the machine-learning model evaluation system 108 determines whether the first prediction requires improvement. The first prediction may require improvement if, for example, the first prediction for one or more of the inputs received at 202 has a high likelihood of being erroneous and/or the confidence level for the prediction falls below a predetermined threshold. For example, referring briefly to FIGS. 3A-3B, while the machine-learning model may accurately predict with confidence that the object shown in FIG. 3A is a car, when noise is added to the image, as shown in FIG. 3B, the machine-learning model may misclassify the image or correctly classify the object as a car but with a lower confidence when compared to the image of FIG. 3A. The likelihood of mistake may be determined by evaluating an internal state of the machine-learning model and performance indicators that can be based on the internal state of the machine-learning model.

Reference is now briefly made to FIG. 3C, which shows an example cluster graph. The cluster graph may be obtained by clustering the machine-learning prediction or an intermediary output of the machine-learning model, for example, a layer of the machine-learning model, based on similarities between images, such that each cluster corresponds to a predefined class. The cluster graph may be a representation of an internal state of the machine-learning model representative of the machine-learning model's internal representation of the inputs. In the cluster graph of FIG. 3C, cluster 310 corresponds to cars, cluster 312 to airplanes and cluster 314 to ships. As shown by datapoint 330 which corresponds to the image of FIG. 3A, when the image contains little noise, the machine-learning model places the image in the cluster 310 associated with cars. However, when evaluating the image of FIG. 3B, which shows the image of FIG. 3A, to which noise has been added, the machine-learning model places the datapoint 332 corresponding to the image on the edge of cluster 310, 312 and 314, that is, the machine-learning model determines that the features of the image contains similarities with the feature distribution associated with each of the three clusters and is accordingly less similar to cars previously encountered by the machine-learning model than the image of FIG. 3A. The location of the datapoints in the clusters can be an indicator of the machine-learning model's likelihood of mistake. While in this case, the machine-learning model accurately predicted the image of FIG. 3B to be a car, the location of datapoint 332 can indicate that the machine-learning model is likely to misclassify the image of FIG. 3B. Similarly, as shown in the cluster graph of FIG. 4B, the machine-learning model may determine that the features of the image of FIG. 4A are most similar to the feature distribution associated with the classification “cats” and accordingly place the datapoint 430 associated with the image of FIG. 4A in the cluster 416 associated with cats. As in FIG. 3B, the location of the datapoint can be indicative of the machine-learning model's perceived similarity between the analyzed features of the input image and features of classes the machine-learning is trained to recognize.

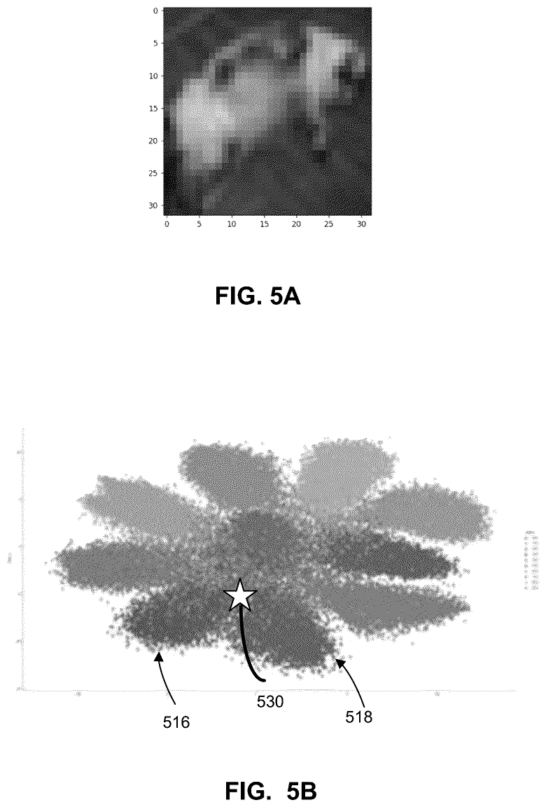

In some cases, the confidence level for the prediction can be correlated with the machine-learning model's evaluation of the data. Referring briefly to FIGS. 5A-5B, the image shown in FIG. 5A may be accurately classified as a cat with a 92.45%. However, as shown in the cluster graph of FIG. 5B, the datapoint 530 corresponding to the image of FIG. 5A lies on the edge of cluster 516, corresponding to cats, and cluster 518, corresponding to dogs, that is, the machine-learning model determined that the features of the image of FIG. 5A were similar to the known feature distributions of both cats and dogs. In such cases, the machine-learning model evaluation system 108 may determine that the machine-learning model has a high likelihood of making a mistake in classifying the image. The determination can be based on the location of the datapoint 530 relative to the clusters, the relationship between the datapoint and neighboring datapoints and/or the confidence level for the prediction.

If the first prediction does not require improvement, for example, the prediction is not associated with a high likelihood of mistake, at 214, the first prediction is accepted. For example, the predictions for the images of FIG. 3A and FIG. 4A may be accepted.

Otherwise, at 210, the machine-learning model evaluation system 108 applies an improved machine-learning model. The improved machine-learning model can be applied to inputs received at 202, for example, to inputs for which the machine-learning model evaluation system 108 determined that an improved machine-learning model was required. For example, the improved machine-learning model may be applied to the images of FIG. 3B and FIG. 5B.

At 212, the machine-learning model evaluation system 108 generates a revised prediction. In some cases, the revised prediction may be evaluated by for example, applying data analytics algorithm(s) to an internal state of the improved machine-learning model and evaluating a location of the datapoint associated with an input, as described with reference to FIGS. 3B, 4B and 5B. Generally, when an improved machine-learning model is applied, the location of the datapoint associated with the input is improved, for example, if a clustering algorithm is used, the datapoint associated with the improved machine-learning model will be relatively closer to the center of a cluster in the cluster graph associated with the improved machine-learning model than the datapoint associated with the first machine-learning model (in the cluster graph associated with the first machine-learning model).

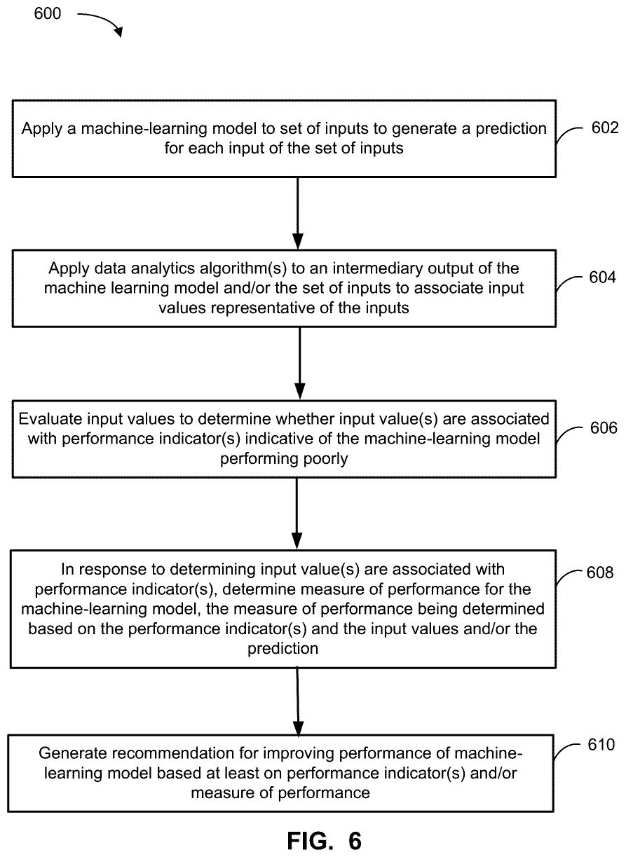

Reference is now made to FIG. 6, which is a flowchart 600 illustrating an example method of operating the machine-learning model evaluation system 108 to evaluate a machine-learning model. The machine-learning model may be any type of machine-learning model capable of generating a prediction. The machine-learning model can be generated with various algorithms, such as, but not limited to, a convolutional neural network. As will be described, when the machine-learning model evaluation system 108 determines that a machine-learning model is performing poorly, the machine-learning model evaluation system 108 can determine whether an improved model can be used to improve the prediction for the input(s) and/or make recommendations for improving the prediction.

At 602, the processor 112 applies the machine-learning model under evaluation to a set of inputs to generate a prediction. The prediction may be a classification prediction and each input in the set of inputs may be assigned a class, for example, as described with reference to method 200. The type of prediction can depend on the type of inputs. For example, in a set of inputs containing images of animals and objects, images may be classified according to the animal or object shown in the image, as determined by the machine-learning model. Referring back to FIG. 3A, the machine-learning model can predict that the object shown in the image is a car. Similarly, the machine-learning model can predict that the object shown in FIG. 4A is a cat.

At 604, the processor 112 applies data analytics algorithms to an intermediary output of the machine-learning model and/or the set of inputs to associate input values representative of the set of inputs. In some cases, the processor 112 may in addition, or alternatively, apply data analytics algorithms to the output of the machine-learning model. Each input value is associated with an input in the set of input. The data analytics algorithms can include clustering algorithms. By applying data analytics algorithm(s), the processor 112 can inspect the internal representation of the input data and the training data of the machine-learning model in the model, for example, by inspecting an internal state of the machine-learning model, and analyze the relationship of each input data sample's internal representation, to the internal representation of every other samples in the dataset. In the case of a neural network machine learning model, the processor 112 can inspect intermediate layer(s) of the machine-learning model to determine the internal representation of the input data. For example, the processor 112 can apply a K-means clustering algorithm to the prediction of the machine-learning model. The input value for an input can for example, be a numerical value representative of the input or a set of numerical values representative of properties of the input. As described, the data analytics algorithm(s) can include clustering algorithm(s). The clustering algorithm(s) can form clusters corresponding to the classification classes, such that the input values of inputs of the same class can generally share similarities.

In some embodiments, in applying the data analytics algorithm(s), the processor 112 can determine similarity scores between input values. The similarity scores can be determined based on a comparison metric, including, but not limited to the distance between input values. For example, input values separated by a short distance may be assigned high similarity scores.

In some embodiments, the processor 112 can operate to display a visual representation of the data analytics algorithms applied and the associated input values in the form of cluster graphs, as shown in FIGS. 3B, 4B and 5B. For example, the processor 112 can apply a t-distributed stochastic neighboring embedding (t-SNE) clustering algorithm to a classification layer of the machine-learning model, for example, the flatten layer or the last classification layer of the machine-learning model and display the cluster graph generated. Input values having high similarity scores may be for example, shown as visually close to one another. Displaying a visual representation of the data analytics algorithm(s) can provide a visual representation of the relationship between different inputs to an operator and identify regions associated with a high likelihood of misclassification.

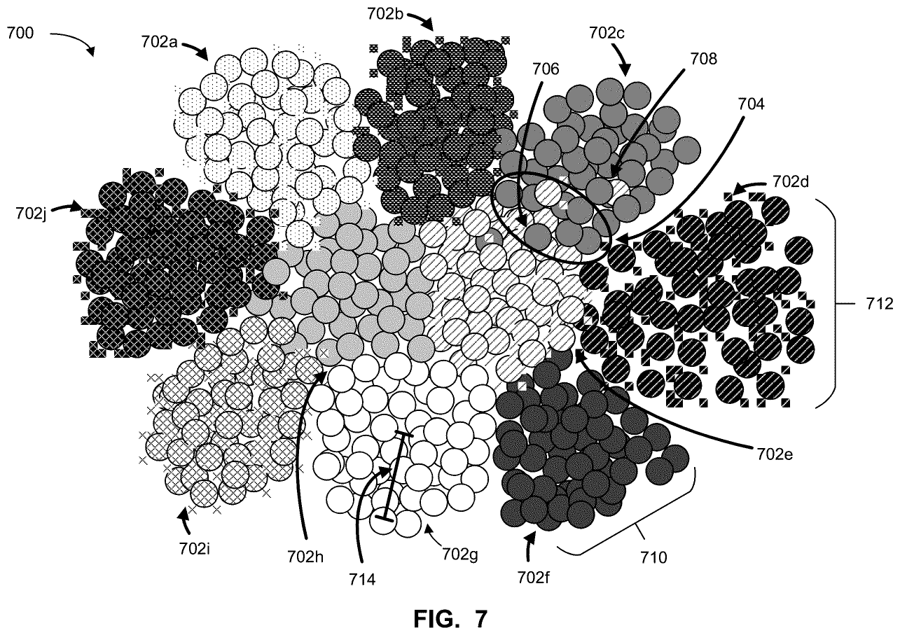

Reference is now briefly made to FIG. 7, which shows an example cluster graph 700 that may be displayed by the processor 112. Each of clusters 702a-702j correspond to a class. Each circle in FIG. 7 can correspond to an image to which the machine-learning model under evaluation has been applied. As shown, the cluster graph 700 includes clusters of datapoints sharing the same classification.

At 606, the processor 112 evaluates the input values to identify a subset of input values associated with performance indicator(s) indicative of the machine-learning model performing poorly.

To evaluate the input values, the processor 112 can evaluate features of the input values. These features can for example, be representative of a location of an input value in a cluster. For example, the processor 112 can evaluate the distance between the input value or a datapoint corresponding to the input value as shown at 714 in FIG. 7, from the center of the cluster and/or a distance between a datapoint and its nearest neighbors. The processor 112 may evaluate the relationship between various input values within a cluster. For example, the processor 112 can determine a measure of clustering of one or more clusters. The measure of clustering can be representative of an average distance between each of the datapoints in the cluster. For example, as shown by 710 in FIG. 7, the datapoints can be tightly clustered or, as shown by 712, the datapoints can be loosely clustered. The processor 112 may also determine an edge of one or more clusters, for example, determine a location of an edge of a cluster, or determine inputs associated with input values located on the edge of a cluster.

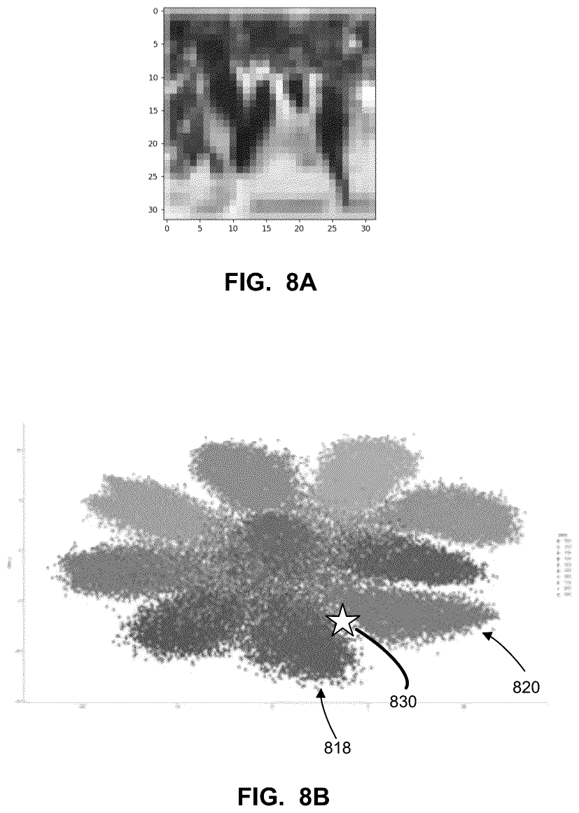

The features evaluated can indicate the performance of the machine-learning model. For example, an image associated with an input value located on the edge of a cluster, as shown by datapoints in region 704 in FIG. 7, may be associated with a poor performance (e.g., a high likelihood of mistake) of the machine-learning model. Input values located on the edge of a cluster may correspond to inputs that, as evaluated by the machine-learning model, shared similarities with more than one class and accordingly, that may be associated with an erroneous prediction, or in some cases, to which the machine-learning model was unable to assign a class with confidence, as exemplified by FIGS. 8A-8B. Referring briefly to FIGS. 8A-8B, FIG. 8A shows an example image of a dog accurately predicted to be a dog with a 95.92% confidence by a machine-learning model. As shown in FIG. 8B, datapoint 830, corresponding to the image shown in FIG. 8A, is located on the edge of cluster 818, corresponding to dogs, and cluster 820, corresponding to horses. As another example, an input value having a distance from the center of the cluster to which the image is associated greater than a pre-determined threshold may be determined to be associated with a poor performance of the machine-learning model. For example, it may be determined that datapoint 830 is located at a distance from the center of clusters 818 and 820 exceeding a pre-determined threshold. As another example, the location of an input value in a cluster may be indicative of the performance of the model. For example, for a given machine-learning model, it may be known or determined that inputs located at a certain location relative to other values within a cluster are associated with a high or a low performance of the machine-learning model. Any combination of these features and of additional features may be evaluated to identify input values associated with substandard characteristics. The features evaluated can correspond to features evaluated during a training stage of the system 110. The performance indicators indicative of the machine-learning model performing poorly may be specific to the machine-learning model being evaluated and/or general to machine-learning classification models.

In some cases, as described, the performance indicators may be experimentally derived for the machine-learning model under evaluation. For example, during training, the processor 112 can apply the machine-learning model to training inputs, apply data analytics algorithms to an intermediary output of the machine-learning model and/or the set of training inputs to associate a training input value to each of the training inputs and evaluate the training input values to identify substandard characteristic(s) indicating that the machine-learning model is performing poorly. In evaluating the training inputs, the processor 112 may evaluate features of the training input values. The performance indicator(s) can be based on the identified substandard characteristic(s) and the training input values associated with the identified substandard characteristic(s).

During the training stage, training inputs with known prediction outcomes and training input values associated with training inputs for which the prediction is incorrect may be evaluated to determine substandard characteristics for the machine-learning model. For example, the training inputs may be labelled with a prediction outcome and the accuracy of the prediction may be determined based on a comparison of the prediction generated by the machine-learning model and the prediction outcome indicated by the label. Training input values may be correlated with prediction outcomes and substandard characteristics determined. In some cases, during the training stage, it may be found that certain prediction outcomes are associated with incorrect predictions. In such cases, substandard characteristics may include prediction outcomes. In some cases, during the training phase, the processor 112 may additionally evaluate the prediction generated by the machine-learning model for the training inputs and determine a measure of confidence for the training inputs and evaluate the training input values associated with a low measure of confidence to identify the substandard characteristics. In such cases, the performance indicators may be based on the identified substandard characteristics associated with the training input values associated with a low measure of confidence. The processor 112 may determine that a prediction is associated with a low measure of confidence when the measure of confidence falls below a predetermined threshold. In some cases where a visual representation of a data analytics algorithm is displayed, it may be possible for an operator to select input data associated with an incorrect prediction and/or to identify and select regions of the visual representation that may be associated with mistakes. In such cases, the substandard characteristic(s) and/or the performance indicator(s) may be determined at least in part based on the operator's selection.

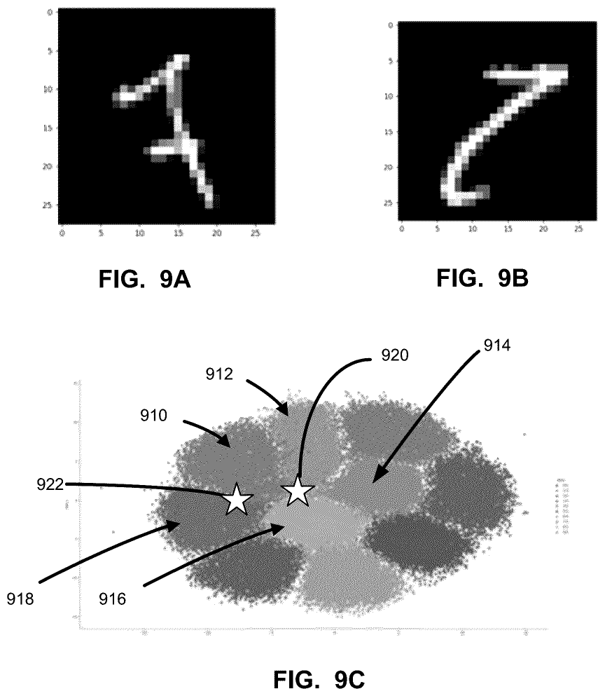

In some embodiments, where the prediction is a classification prediction, evaluating the input values to identify the subset of input values associated with performance indicators involves identifying the class to which each of the input associated with the input values is assigned and evaluating the input values associated with the identified class(es). For example, for a given machine-learning model, it may be known or determined during a training phase that inputs assigned to a particular class are associated with a high likelihood of a mistake in the prediction. A machine-learning model for classifying images of numbers for example, may occasionally misclassify the number 7 as the number 1 or the number 2. Reference is briefly made to FIGS. 9A-9B, which show example images of a handwritten number 7 that may be misclassified by a machine-learning model as the number 1 and the number 2, respectively. As shown in the cluster graph of FIG. 9C, datapoint 920, corresponding to the image of FIG. 9A, is located on the edge of cluster 910, corresponding to the number 7, cluster 912, corresponding to the number 1, cluster 914, corresponding to the number 9 and cluster 916, corresponding to the number 8 while datapoint 922, corresponding to the image of FIG. 9B is located on the edge of cluster 910 and cluster 918, corresponding to the number 2. As shown by the locations of the datapoints, the number 7 can be a class that is associated with a high likelihood of misclassification. By identifying the class to which the images are assigned, the processor 112 may determine the performance of the machine-learning model, as will be described in further detail below. In addition, during the training phase, the processor 112 may evaluate features of the training input values assigned to these classes to identify the substandard characteristic(s) and determine the performance indicator(s).

Referring back to FIG. 7, datapoint 708 may be identified as an input value associated with performance indicators indicative of the machine-learning model performing poorly based on its location relative to other datapoints of the same type. Similarly, region 704 may be associated with performance indicators such that datapoints such as datapoint 706 may be identified as being associated with the machine-learning model performing poorly.

As described above, the processor 112 can identify the subset of input values that is associated with the performance indicator(s), that is, the processor 112 can identify the subset of input values associated with the machine-learning model performing poorly and accordingly, the subset of inputs to which the machine-learning model was applied for which the prediction is or may be incorrect. A poor performance of the machine-learning model can be characterized by for example, a high likelihood of the machine-learning model making an erroneous prediction, the classification being inaccurate, or the confidence level for the prediction falling below a pre-determined threshold.

In some embodiments, the processor 112 can evaluate the prediction generated by the machine-learning model to determine a measure of confidence for the prediction and evaluate the input values for those inputs associated with a low measure of confidence. For example, the machine-learning model may generate a measure of confidence for each prediction and the processor 112 may evaluate the input values for inputs associated with a measure of confidence falling below a threshold. Alternatively, or in addition, the processor 112 may determine the measure of performance of the machine-learning model at least in part on the measure of confidence for the prediction, as will be described in further detail below.

Referring back to FIG. 6, at 608, in response to identifying the subset of input values associated with the performance indicator(s) indicating the machine-learning model is performing poorly, the processor 112 determines a measure of performance for the machine-learning model. The measure of performance can indicate that the prediction for an input is or is not likely to be erroneous due to the machine-learning model performing poorly and can correspond to an assessment of the performance of the machine-learning model for the inputs received. The measure of performance can include a quantitative or qualitative likelihood of a prediction being erroneous, based on for example, the presence of specific performance indicator(s) and/or the number of performance indicator(s) determined at 606.

As described, the measure of performance is determined based on the performance indicator(s) identified and the input values associated with the set of inputs, and/or the prediction from the machine-learning model for the inputs. For example, the measure of performance can be determined based on features of the input values and the presence of one or more of the performance indicators.

As another example, based on the evaluation of the input values and/or the prediction, the processor 112 may determine that the inputs are associated with a specific prediction, known to be associated with a high likelihood of the machine-learning model performing poorly and accordingly the measure of performance may indicate that the prediction has a high likelihood of being erroneous.

In cases where more than one data analytics algorithm is applied, the processor may evaluate the input values obtained according to each of the data analytics algorithms applied, as described at 604 and 606, and determine the measure of performance based on performance indicator(s) associated with each of the data analytics algorithms. For example, the processor 112 may determine the measure of performance based on shared performance indicator(s) or on a combination of performance indicator(s). In addition, in some embodiments, during the training stage, where more than one data analytics algorithm is applied, the processor may evaluate the training input values obtained according to each of the data analytics algorithms and determine the performance indicator(s) based on substandard characteristics associated with each of the data analytics algorithms. For example, the processor 112 may determine the performance indicator(s) based on a combination of substandard characteristics or on a subset of shared substandard characteristics.

In some embodiments, the processor 112 can evaluate the performance of the machine-learning model by determining attributes evaluated by the machine-learning model to generate the prediction. For example, the processor 112 can analyze neurons active during the generation of the prediction and compare the result of the analysis to known patterns of activation or patterns determined during the training phase. As another example, the processor 112 can apply a gradient-based technique such as a Gradient-weighted Class Activation Mapping (Grad-CAM) technique and/or a local interpretable model-agnostic explanations (LIME) technique. The processor 112 can evaluate the determined attributes for the inputs and determine the measure of performance of the machine-learning model based at least on a comparison between the determined attributes and attributes determined or known to be associated with the machine-learning model performing poorly. For example, during a training phase, the processor 112 can determine attributes evaluated by the machine-learning model when the machine-learning model is performing poorly, and determine a subset of shared attributes amongst the determined attributes. At 608, the processor 112 can compare the attributes evaluated by the machine-learning model for the inputs and compare these attributes with the shared attributes determined during the training stage. Alternatively, or in addition, the data analytics algorithm(s) can include algorithms for determining attributes determined by the machine-learning model to generate the prediction and the determined attributes may be evaluated at 606, when the processor 112 evaluates the input values. In such cases, the performance indicator(s) may include or be at least in part based on attributes associated with the machine-learning model performing poorly for example, the shared attributes determined during the training phase. Alternatively, or in addition, when the data analytics algorithm(s) include clustering algorithm(s), the processor 112 can determine the attributes for inputs associated with a specific cluster or specific clusters, a region within a cluster and/or one or more input values within the subset of input values associated with performance indicator(s) indicating the machine-learning model performing poorly. Similarly, the attributes evaluated by the machine-learning model during the training phase may be determined for a subset of training inputs, for example, for the training inputs associated with a specific cluster or specific clusters, a region within a cluster and/or one or more training input values within the subset of training input values associated with the machine-learning model performing poorly.

When the machine-learning model is an image classification model, the processor 112 can apply for example a Grad-CAM technique to the machine-learning model's representation of the images evaluated by the machine-learning model in generating its predictions. The Grad-CAM technique may be applied to the machine learning model's representation of all inputs or a subset of inputs associated with the performance indicator(s) indicating the machine-learning model is performing poorly and to the machine learning model's representation of the training inputs and/or the subset of training inputs associated with the machine-learning model performing poorly.

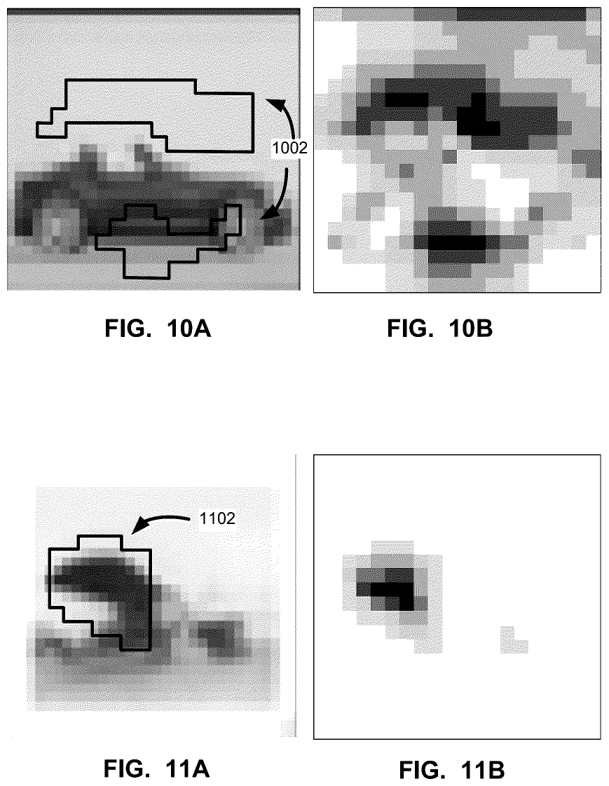

Reference is now briefly made to FIGS. 10A-10B and FIGS. 11A-11B, which show example analyses of attributes evaluated by the machine-learning model using a Grad-CAM algorithm. FIG. 10A shows an image of an automobile misclassified by the machine-learning model as an airplane. Regions generally referenced with 1002 are regions of the image used by the machine-learning model to make its prediction and FIG. 10B shows a heatmap of the regions of the image used by the machine-learning model to make its prediction. As can be seen, the machine-learning model did not evaluate the appropriate regions of the image and accordingly misclassified the image.

By contrast, in FIGS. 11A-11B, FIG. 11A shows an image of an airplane correctly classified by the machine-learning model. Region 1102 shows the region of the image primarily used by the machine-learning model to make its prediction and FIG. 11B shows a heatmap of the regions of the image used by the machine-learning model to make its prediction. As can be seen, the machine-learning model evaluated an appropriate region of the image and accordingly correctly classified the image.

The processor 112 can determine the measure of performance of the machine-learning based on these attributes to identify inputs that are likely to be misclassified. For example, the processor 112 can determine that the machine-learning model is likely to make an erroneous prediction, for example, misclassify an image, when it determines that the machine-learning model evaluated certain attributes of the inputs.

Returning to FIG. 6, at 610, the processor 112 generates a recommendation for improving the performance of the machine-learning model based at least on the one or more performance indicator(s) and/or the measure of performance. The recommendation can include, for example, an indication that the machine-learning model is performing poorly and/or that the prediction should not be accepted, specific prediction outcomes (e.g., classes) associated with the machine-learning model performing poorly, the performance indicators, the measure of performance, specific issues with the machine-learning model and/or recommendations for improving the prediction and/or the machine-learning model (e.g., applying an improved machine-learning model, receiving additional input data, using a machine-learning model trained using another training data set or trained with specific training data, requiring human intervention).

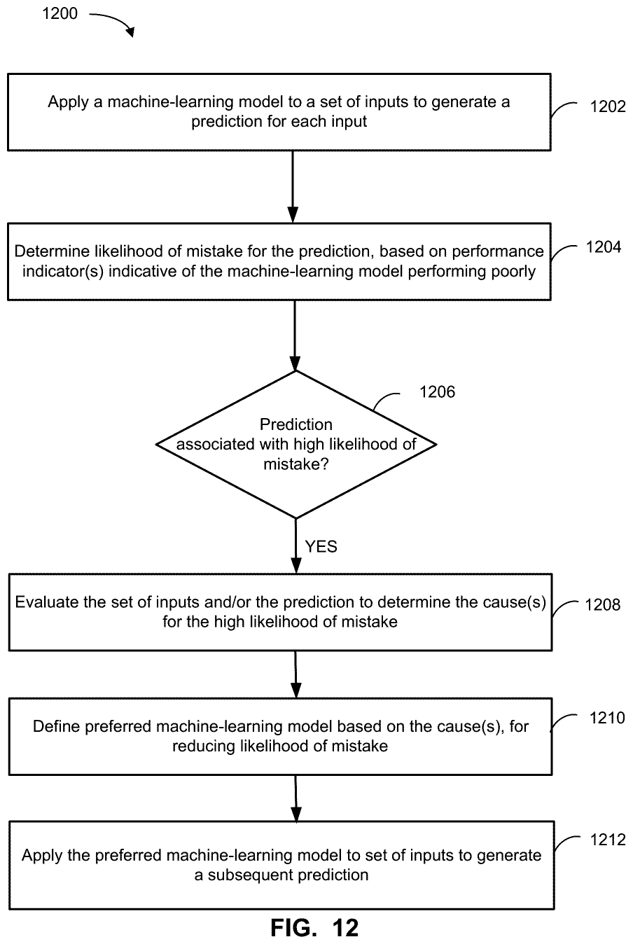

Reference is now made to FIG. 12, which shows a flowchart 1200 of an example method of improving a prediction generated by a machine-learning model. The machine-learning model can be any machine-learning model for which performance indicators have been developed or to which existing performance indicators can be applied.

At 1202, the processor 112 applies the machine-learning model to the set of inputs to generate a prediction for the inputs in the set of inputs.

At 1204, the processor 112 determines a likelihood of mistake in the prediction based on one or more performance indicators indicative of the machine-learning model performing poorly. The performance indicators can be for example, the performance indicators determine during a training stage, that is, the performance indicators can be based on substandard characteristics of training input values associated with training inputs associated with the machine-learning model performing poorly and/or prediction outcomes associated with the machine-learning model performing poorly. The processor 112 may determine the likelihood of a mistake (i.e., likelihood of misclassification) based on the presence of one or more of the performance indicators. The performance indicators can be stored in a database and accessed by the processor 112. The processor 112 may determine the likelihood of a mistake of the prediction based on the performance indicators for the machine-learning model. For example, based on the prediction determined by the machine-learning model, the processor 112 may determine that the prediction is associated with a high likelihood of a mistake.

In some embodiments, to determine the likelihood of mistake, the processor 112 can apply data analytics algorithm(s) to the inputs to associate an input value to each of the inputs to which the machine-learning model is applied and evaluate features of the input value associated with each input value to determine if the input value is associated with the performance indicators. For example, the processor 112 may apply clustering algorithm(s) to the input data, evaluate a location of the datapoint associated with each input, and determine if the location of the datapoint is associated with high likelihood of misclassification, as determined by the performance indicators.

At 1206, the processor 112 evaluates whether the prediction is associated with a high likelihood of mistake. The processor 112 can evaluate whether the prediction is associated with high likelihood of mistake based on the performance indicators and in some cases, by additionally determining a measure of confidence of the prediction for each of the inputs to which the machine-learning model is applied and determining if the measure of confidence falls below a confidence threshold, in which case the prediction can be associated with a high likelihood of mistake. The likelihood of mistake may be determined to be high if the likelihood exceeds a predetermined threshold and the determination of the likelihood may be based on the presence of performance indicators indicative of the machine-learning model performing poorly. In some cases, the measure of confidence can be generated by the machine-learning model as part of the prediction. The confidence threshold can be based on the type of the set of inputs. For example, as described with reference to FIGS. 9A-9B, for image classification of handwritten numbers, it may be known that the numbers 7, 1 and 2 tend to be misclassified and accordingly, the confidence threshold for classification of numbers may be higher than for images that are seldom misclassified. As another example, based on the type of use for the prediction, varying trust in the prediction may be required. For example, safety critical applications may require a high level of trust in the predictions and accordingly, the acceptable likelihood of mistake may be lower and/or the confidence threshold may be higher.

The confidence threshold and/or the threshold for a high likelihood of mistake may also be received by the processor, for example, via a user input received by the computing device 106 and transmitted to the system 108 via the communication component 114.

If the processor 112 determines that the prediction is associated with a high likelihood of mistake, at 1208 the processor 112 evaluates the set of inputs and/or the prediction to determine the cause(s) of the high likelihood of mistake. If the processor 112 determines that the prediction is not associated with a high likelihood of mistake, the prediction of the machine-learning model is determined to not require improving. In some embodiments, when the processor 112 determines that the prediction is associated with a high likelihood of mistake, the processor 112 can generate an alert, to notify an operator of the high likelihood of mistake, as described at 610. The processor 112 may additionally, or alternatively generate instructions for receiving new input data. For example, in cases where the machine-learning model evaluation system 108 is used to process real-time data from a device (e.g., the computing device 106), the processor 112 may determine that a prediction with a low likelihood of mistake could not be obtained based on the input data received, and instruct the device to transmit additional or new input data. The action taken by the processor 112 may be determined in part based on the type of input data and/or the use case.

In some cases, the processor 112 can identify attributes of the inputs evaluated by the machine-learning model in generating its predictions. For example, the processor 112 can apply a Grad-CAM algorithm to the machine-learning model's representation of inputs to determine if the prediction is associated with a high likelihood of mistake. For example, a high likelihood of mistake may be correlated with the machine-learning model evaluating the unexpected attributes of the inputs or with the machine-learning model evaluating certain attributes known to be associated with a high likelihood of mistake, as described with reference to method 600.

At 1210, the processor 112 defines a preferred machine-learning model based on the cause(s) of high likelihood of mistake.

The preferred machine-learning model can be defined by selecting or generating a machine-learning model to improve the prediction of the machine-learning model by for example, targeting the cause of the poor performance, and may be a more powerful, more resource-intensive machine-learning model than the machine-learning model. The processor 112 may select the preferred machine-learning model based in part on the confidence threshold. For example, a low confidence threshold may indicate that the processor 112 was unable to classify the inputs with confidence and accordingly, the preferred machine-learning model selected may be a machine-learning model that is different from the machine-learning model. The processor 112 may alternatively, or in addition, select the preferred machine-learning model based on the type of the set of inputs and/or type of the prediction, for example, a class of a classification prediction. For example, the preferred machine-learning model may be a specialized machine-learning model for distinguishing between specific classes, for example, in the case of number classification, between the numbers 1, 2 and 7. In some cases, the preferred machine-learning model may be selected by an operator.

The processor 112 may select or generate the preferred machine-learning model based on the attributes evaluated by the machine-learning model to determine the prediction. For example, the preferred machine-learning model may be selected or generated to target attributes that were not evaluated by the machine-learning model.

At 1212, the processor 112 applies the preferred machine-learning model to input(s) to generate a subsequent prediction for the inputs. The input(s) to which the preferred machine-learning model is applied can be input(s) associated with performance indicators indicating a high likelihood of a mistake, and can correspond to, for example, input(s) lying within a region of the cluster graph associated with the set of inputs associated with a high likelihood of a mistake. By applying the preferred machine-learning model to only a subset of the inputs applied to the machine-learning model, resources associated with applying the preferred machine-learning model need not be expended on making predictions for inputs for which predictions can be made with confidence by the machine-learning model. This can be particularly advantageous when the preferred machine-learning model is a resource-intensive, specialized model.

In some embodiments, when the machine-learning model evaluation system 108 is used in a system which applies machine-learning models to generate predictions, the machine-learning model evaluation system 108 can evaluate a quality of the predictions and to determine whether the prediction is likely to require improvement. To evaluate the prediction, the processor 112 can simulate the operation of the system when the prediction is used to determine expected state(s) of the system. The machine-learning model evaluation system 108 can then compare the expected state(s) of the system and the actual state(s) of the system to determine whether the prediction may be incorrect.

For example, the vision system of a vehicle which uses machine-learning model(s) to make predictions to assist with lane merging may predict that a lane is free and that the vehicle can proceed to merge. The processor 112 may simulate the operation of the vehicle and determine that if the prediction “lane is free” is correct, an expected state of the vehicle will be “the vehicles moves to the new lane”. However, if, in the process of merging, the vehicle detects another vehicle in the new lane, using, for example proximity sensors, the vehicle will remain in the initial lane and the actual state of the vehicle will be “vehicle in original lane”. In this example, the machine-learning model evaluation system 108 may determine that the expected state and the actual state of the system (i.e., the vehicle) differ and that the prediction of the vision system (i.e., lane is free) was incorrect and further improvement is required.

In some embodiments, the processor 112 can evaluate an input that led to the incorrect prediction to identify input features that caused the incorrect prediction. For example, one approach with cluster graph analysis can involve operating the processor 112 to determine a cluster graph location within the cluster graph corresponding to the input associated with the incorrect prediction. The processor 112 can then associate the cluster graph location, and possibly neighbouring locations, with potentially incorrect predictions. The processor 112 can identify the cluster graph location as a location requiring improvement—e.g., via retrieval of additional data and/or more current data.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high-level procedural or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims.

1. A system for evaluating a performance of a machine-learning model, the system comprising:
a database having a set of inputs stored thereon; and
a processor in communication with the database, wherein the processor is operable to:
apply the machine-learning model to the set of inputs to generate a prediction for each of the inputs in the set of inputs;
apply one or more data analytics algorithms to one of an intermediary output of the machine-learning model and the set of inputs for associating an input value to each input of the set of inputs;
evaluate the input values associated with the set of inputs to determine whether one or more input values are associated with one or more performance indicators indicating the machine-learning model is performing poorly;
in response to determining the one or more input values are associated with the one or more performance indicators indicating the machine-learning model is performing poorly, determine a measure of performance for the machine-learning model, the measure of performance being determined based on one or more of the one or more performance indicators and the input values associated with the set of inputs, and the prediction generated for the inputs; and
generate a recommendation for improving the performance of the machine-learning model based at least on one or more of the one or more performance indicators and the measure of performance.

2. (canceled)

3. (canceled)

4. The system of claim 1, wherein the processor is operable to:
apply the machine-learning model to a set of training inputs to generate a prediction for each of the training inputs in the set of training inputs;
apply the one or more data analytics algorithms to one of the intermediary output of the machine-learning model and the set of training inputs for associating a training input value to each training input of the set of inputs;
evaluate the training input values associated with the set of training inputs to determine one or more substandard characteristics indicating the machine-learning model is performing poorly; and
determine the one or more performance indicators based at least on the one or more substandard characteristics and the training input values associated with the one or more substandard characteristics.

5. (canceled)

6. (canceled)

7. (canceled)

8. The system of claim 1, wherein applying the one or more data analytics algorithms comprises determining, for the intermediary output of the machine-learning model, a plurality of similarity scores, wherein each similarity score indicates a similarity between a first input value of the plurality of input values and a second input value of the plurality of input values based on a comparison metric between the first input value and the second input value.

9. (canceled)

10. (canceled)

11. The system of claim 4, wherein the processor is operable to:
for the training inputs associated with the subset of training input values associated with the substandard characteristics, determine a plurality of attributes of the training inputs evaluated by the machine-learning model to generate the prediction;
determine a subset of shared attributes within the plurality of attributes; and
determine the one or more performance indicators based on the determined subset of shared attributes.

12. (canceled)

13. The system of claim 11, where in the processor is operable to:
determine a plurality of attributes of the inputs evaluated by the machine-learning model to generate the prediction; and
determine the measure of performance of the machine-learning model based at least on a comparison of the plurality of attributes evaluated by the machine-learning model and the subset of shared attributes.

14. The system of claim 4, wherein evaluating the plurality of training input values to identify the subset of training input values associated with substandard characteristics comprises identifying one or more prediction outcomes associated with the machine-learning model performing poorly and evaluating the plurality of training input values associated with the one or more prediction outcomes.

15. (canceled)

16. The system of claim 4, wherein the processor is operable to:
evaluate the prediction to determine a measure of confidence for the prediction for each of the training inputs in the set of training inputs;
evaluate the training input values associated with a low measure of confidence for the prediction to identify the substandard characteristics; and
determine the one or more performance indicators based on the identified substandard characteristics associated with the training input values.

17. (canceled)

18. (canceled)

19. The system of claim 4 wherein determining the one or more performance indicators comprises:
evaluating a first plurality of training input values obtained according to a first data analytics algorithm to identify one or more first substandard characteristics of a first subset of input values associated with the machine-learning model performing poorly;
evaluating a second plurality of training input values obtained according to a second data analytics algorithm to identify one or more second substandard characteristics of a second subset of input values associated with the machine-learning model performing poorly; and
determining the one or more performance indicators based on the first substandard characteristics and the second substandard characteristics.

20. The system of claim 1, wherein determining the one or more performance indicators comprises identifying whether the prediction is associated with a prediction outcome associated with the machine-learning model performing poorly.

21. (canceled)

22. A method for evaluating a performance of a machine-learning model, the method comprising operating a processor to:
apply the machine-learning model to a set of inputs to generate a prediction for each of inputs in the set of inputs;
apply one or more data analytics algorithms to one of an intermediary output of the machine-learning model, and the set of inputs for associating an input value to each input in the set of inputs;
evaluate the input values associated with the set of inputs to determine whether one or more input values are associated with one or more performance indicators indicating the machine-learning model performing poorly;
in response to determining the one or more input values are associated with the one or more performance indicators indicating the machine-learning model is performing poorly, determine a measure of performance for the machine-learning model, the measure of performance being determined based on one or more of the one or more performance indicators and the input values associated with the set of inputs, and the prediction generated for the inputs; and
generate a recommendation for improving the performance of the machine-learning model based at least on one or more of the one or more performance indicators and the measure of performance.

23. (canceled)

24. (canceled)

25. The method of claim 22, wherein the method further comprises operating the processor to:
apply the machine-learning model to a set of training inputs to generate a prediction for each of the training inputs in the set of training inputs;
apply the one or more data analytics algorithms to one of the intermediary output of the machine-learning model and the set of training inputs for associating a training input value to each training input of the set of inputs;
evaluate the training input values associated with the set of training inputs to determine the one or more substandard characteristics indicating the machine-learning model is performing poorly; and
determine the one or more performance indicators based at least on the one or more substandard characteristics and the training input values associated with the one or more substandard characteristics.

26. (canceled)

27. (canceled)

28. (canceled)

29. The method of claim 22, wherein applying the one or more data analytics algorithms comprises determining, for the intermediary output of the machine-learning model, a plurality of similarity scores, wherein each similarity score indicates a similarity between a first inputs value of the plurality of inputs values and a second inputs value of the plurality of inputs values based on a comparison metric between the first inputs value and the second inputs value.

30. (canceled)

31. (canceled)

32. The method of claim 25, wherein the method further comprises operating the processor to:
for the training inputs associated with the subset training input values associated with the substandard characteristics determine a plurality of attributes of the training inputs evaluated by the machine-learning model to generate the prediction;
determine a subset of shared attributes within the plurality of attributes; and
determine the one or more performance indicators based on the determined subset of shared attributes.

33. (canceled)

34. The method of claim 32, wherein the method further comprises operating the processor to:
determine a plurality of attributes of the inputs evaluated by the machine-learning model to generate the prediction;
determine the measure of performance of the machine-learning model based at least on a comparison of the plurality of attributes evaluated by the machine-learning model and the subset of shared attributes.

35. The method of claim 25, wherein evaluating the plurality of training input values to identify the subset of training input values associated with substandard characteristics comprises identifying one or more prediction outcomes associated with the machine-learning model performing poorly and evaluating the plurality of training input values associated with the one or more prediction outcomes.

36. (canceled)

37. The method of claim 25, wherein the method further comprises operating the processor to:
evaluate the prediction to determine a measure of confidence for the prediction for each of the training inputs in the set of training inputs;
evaluate the training input values associated with a low measure of confidence for the prediction to identify the substandard characteristics; and
determine the performance indicator for the inputs based on the identified substandard characteristics associated with the training input values.

38. (canceled)

39. (canceled)

40. The method of claim 22, wherein determining the one or more performance indicators comprises:
evaluating a first plurality of training input values obtained according to a first data analytics algorithm to identify one or more first substandard characteristics of a first subset of input values associated with the machine-learning model performing poorly;
evaluating a second plurality of training input values obtained according to a second data analytics algorithm to identify one or more second substandard characteristics of a second subset of input values associated with the machine-learning model performing poorly; and
determining the one or more performance indicators based on the first substandard characteristics and the second substandard characteristics.

41. The method of claim 22, wherein determining the one or more performance indicators comprises identifying one or more prediction outcomes associated with the machine-learning model performing poorly.

42. (canceled)

43. A system for improving a prediction generated by a machine-learning model, the system comprising:
a database having a set of inputs stored thereon; and
a processor in communication with the database and operable to:
apply the machine-learning model to the set of inputs to generate the prediction for each input of the set of inputs;
determine a likelihood of mistake for the prediction; and
in response to determining that the prediction is associated with a high likelihood of mistake:
evaluate one or more inputs of the set of inputs and the respective prediction to determine one or more causes for the high likelihood of mistake;
define a preferred machine-learning model based on the one or more causes for reducing the likelihood of mistake for the prediction; and
apply the preferred machine-learning model to one or more inputs of the set of inputs to generate a subsequent prediction for the one or more inputs.

44. (canceled)

45. The system of claim 43, wherein the processor is operable to determine the likelihood of mistake of the prediction based on one or more performance indicators indicative of the machine-learning model performing poorly.

46.-78. (canceled)
